(19) United States
(12) Patent Application Publication
(10) Pub. No.: US 2007/0196532 A1
(43) Pub. Date: Aug. 23, 2007

(54) Punch or die for tabletting

(76) Inventor: Kazuo Sawaguchi, Itano-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/596,222

(22) PCT Filed: May 15, 2006
(86) PCT No.: PCT/JP06/09651

§ 371 Date: Nov. 14, 2006

(30) Foreign Application Priority Data
May 16, 2005 (JP) 2005-143311

(51) Int. Cl. A01J 21/00

(52) U.S. Cl. 425/425

(57) ABSTRACT

An object of the Invention is to provide a punch or die for tabletting to be excellent durability and releasability. When a coating layer is provided on a surface, the coating layer is yet securely prevented from detachment. In the punch or die for tabletting, the tablet-forming surface layer 5 contains a base metal and a hardening metal in a fused state which is different from the base metal, and a hardening metal content is incremental from the base metal toward the tablet-forming surface layer 5. The hardening metal contains at least any one of W, C, B, Ti, N, and Cr. Furthermore, in the punch or die for tabletting, the tablet-forming surface layer 5 ranges between 0.1 μm and 5 μm in terms of arithmetical mean roughness Ra of the surface.

### TECHNICAL FIELD

The present invention relates to a punch or die for compressing drug powder.

### BACKGROUND ART

A punch or die for tabletting is required to have durability and releasability. Several kinds of punches or dies have been developed in order to meet such a requirement. Refer to Patent Documents 1 to 4 as described below.

Described in Patent Document 1 is such a technique that, in compressing a corrosive material to form a tablet, corrosion resistance of a punch or die is improved by forming the punch or die with metal such as Ti, Ti alloy, Ni—Cr—Mo based alloy, Ni—Mo based alloy, Co-based alloy, or by coating the surface of the punch or die with any one of diamond-like C, Ti, titanium nitride, chromium nitride and a double coat of Ti-Titanium nitride.

Described in Patent Document 2 is such a technique that a tablet-forming plane of a punch is treated with chromium-dopé-N coating in order to obtain excellent corrosion resistance and releasability required of a punch which is used with a tablet press for forming a tablet containing an acidic substance or adherent substance.

Described in Patent Document 3 is such a technique that a punch or die is formed with a sintered alloy which has a high mechanical property and excellent corrosion resistance. The punch or die is made of a sintered alloy having excellent corrosion resistance, with 0.2-5% by weight of at least any one of tantalum (Ta) and niobium (Nb) being added to an ingredient which contains 36-53% by weight of cobalt (Co), 27-35% by weight of chromium (Cr), 10-20% by weight of tungsten (W), and 2-3% by weight of carbon (C), to be sintered in a conventional manner.

Described in Patent Document 4 are a punch and die in which high-silicon steel is employed as a base metal and the base metal has its surface treated with carburization in order to obtain corrosion resistance and releasability.

Patent Document 1: Japanese Patent Laid-Open Publication No. 2003-210553

Patent Document 2: Japanese Patent Laid-Open Publication No. 2001-71189

Patent Document 3: Japanese Patent Laid-Open Publication No. 1999-158571

Patent Document 4: Japanese Patent Laid-Open Publication No. 2002-1593

### DISCLOSURE OF INVENTION

### Problem to be Solved by the Invention

The punches or dies as described in these patent documents cannot form a full range of drug powder, with sufficient durability as well as with sufficient adhesion-preventive releasability. For example, sufficient durability and releasability cannot be obtained in the case of the punch and die which is described in Patent Document 1 to have Ti as a base metal. Also in the case of the punch or die having a coating layer provided on a surface of the base metal, even if its durability and releasability may be improved with the aid of the coating layer, there occurs a disadvantage that the coating layer is prone to be detached when the punch or die is in use, causing a tablet to be contaminated by the metal of the coating layer. In the case of the sintered metal as described in Patent Document 3, it is disadvantageous that its insufficient impact resistance is likely to cause a tablet to be contaminated by broken metal fragments. The carburized punch or die as described in Patent Document 4 is unable to obtain sufficient durability, although a tablet is not likely to have a disadvantage of being contaminated by metal.

The present invention has been made in order to solve the above-mentioned disadvantages which are inherent in conventional types of punches or dies. It is an important object of the present invention to provide a punch or die for tabletting which has excellent durability and releasability so that, even when a coating layer is provided on a surface, such coating layer can be securely prevented from being detached.

### Means to Solve the Problem

The inventive punch or die for tabletting includes the following construction in order to achieve the afore-mentioned object(s). In the punch or die for tabletting, the tablet-forming surface layer (5) includes a base metal as well as a hardening metal which is different from the base metal, with a hardening metal content being incremental from the base metal toward the tablet-forming surface layer (5). The hardening metal contains at least any one of W, C, B, Ti, N, and Cr. Also, in the punch or die for tabletting, an arithmetical mean roughness Ra of a surface in the tablet-forming surface layer (5) ranges between 0.1 μm and 5 μm.

In the inventive punch or die for tabletting, a hardening metal content of the tablet-forming surface layer (5) can have a hardening metal content of 20% or more by weight of the base metal. Further, the inventive punch or die for tabletting can range between 1 μm and 5 μm in thickness of the tablet-forming surface layer (5).

In the inventive punch or die for tabletting, the base metal can be any one of iron, iron alloy, Ti, Ti alloy, stainless steel, and sintered metal. Further, in the inventive punch or die for tabletting, the base metal can be made of titanium or titanium alloy, while the hardening metal can be made of W and C.

In the inventive punch or die for tabletting, the tablet-forming surface layer (5) can have a coating layer provided on its surface. The coating layer can be any one of chromium nitride, diamond-like C, titanium nitride, chromium-dopé-N, titanium carbide, hard chromium plating, and electroless nickel plating.

In the inventive punch or die for tabletting, the surface of the base metal can be electrically discharged with an electrode containing a hardening metal, so that the tablet-forming surface layer (5) may contain the hardening metal.

In the inventive punch or die for tabletting, the surface of the tablet-forming surface layer (5) can be blasted with a particulate (and/or powdery) object, allowing an arithmetical mean roughness Ra of the surface to be controlled.

### Effect of the Invention

The inventive punch or die for tabletting carries an advantage that excellent durability and releasability can be obtained. This is possible because the inventive punch or die for tabletting has a tablet-forming surface layer which contains a base metal as well as a hardening metal being different from the base metal; a hardening metal content of the tablet-forming surface layer is arranged to be incremental from the base metal toward the tablet-forming surface layer; and the tablet-forming surface layer is arranged to range between 0.1 μm and 5 μm in terms of arithmetical mean roughness Ra of a surface. The tablet-forming surface layer arranged to contain a hardening metal within a base metal can thus become hardened to an extremely high hardness, so that its durability can be improved to a remarkable extent. Especially, by arranging the hardening metal content to be incremental from the base metal toward the tablet-forming surface layer, the surface side of the tablet-forming surface layer can be hardened to an ideal extent. Furthermore, since the tablet-forming surface layer is arranged to range between 0.1 μm and 5 μm in terms of arithmetical mean roughness Ra of the surface, excellent releasability can be obtained to allow drug powder to be ideally released.

Furthermore, the punch or die for tabletting in accordance with a sixth invention carries an advantage that even more excellent durability and releasability can be obtained because a coating layer is provided on the surface of the tablet-forming surface layer. Especially, the inventive punch or die for tabletting carries an advantage that a duration of time to be involved in detachment of the coating layer which is provided on the surface of the tablet-forming surface layer can be elongated significantly, by four to five times, as compared with a duration of time to be involved in detachment of conventional coating layer. This is possible because the coating layer is joined with the base metal via the tablet-forming surface layer which contains the hardening metal. Thus, in the case of the inventive punch or die for tabletting in which the coating layer can be joined with the base metal in a less-likely-to-be-detached state, an advantage can be realized in that both the durability and the drug powder releasability can be improved; that a duration of time to be involved in detachment of the coating layer can be elongated substantially; that the tablets can be effectively prevented from being contaminated by a detached coating layer; and that a great number of tablets can be efficiently formed.

### BEST MODE FOR CARRYING OUT THE INVENTION

Embodiments in accordance with the present invention shall be described hereinafter in conjunction with the accompanying drawings. It should be noted, however, that the ensuing description of embodiments is merely illustrative of the punch or die for tabletting only to embody technical ideas conceived in the present invention and that the invention shall in no way be limited to the punch or die described below.

To add, in the present disclosure, reference numerals corresponding to members shown in the embodiments are affixed to members shown in the “CLAIMS” and “MEANS TO SOLVE THE PROBLEM” in order to facilitate a better understanding of the claims. However, those members shown in the claims shall in no way be specified to those members shown in the embodiments.

In a tablet press shown in FIG. 1, a punch 1 and die 2 are designed to press drug powder for tablet formation. The tablet press is provided with a die bore 3 extending vertically along a center (an axis) of the die 2. Inserted through the die bore 3 are a lower punch 1B from the bottom and an upper punch 1A from the top. A volumetric capacity for tablet formation is determined by adjusting a vertical position of the lower punch 1B. When the lower punch 1B is placed in position, the drug powder is filled into the die bore 3. In this state, the upper punch 1A is inserted into the die bore 3, so that the drug powder is compressed to form a tablet. Then, when the lower punch 1B is elevated, a formed tablet is taken out of the die bore 3.

A tabletting pressure, employed when the upper punch 1A presses the drug powder, ranges from 1 to 30 kN for example, preferably from 5 to 30 kN, and more preferably from approximately 8 to 25 kN. An inner diameter of the die bore 3 ranges from 3 mm to 20 mm for example, preferably from approximately 3 mm to 13 mm, and more preferably from 4 mm to 10 mm. Further, the die bore 3 can be in a cylindrical shape or with an irregular cross section which may be oval or oblong, and the like. In the lower punch 1B and the upper punch 1A respectively, its tip to be inserted into the die bore 3 is so designed as to be cylindrical and to have a diameter which is generally equal to but, more precisely, slightly smaller than the inner diameter of the die bore 3. The punches can thus be smoothly inserted into the die bore 3 for tablet formation, without the drug powder leaking from between the punches and the die bore 3.

As shown in the enlarged cross-sectional view in FIG. 1, the punch 1 has a tablet-forming surface layer 5 provided over a tablet-forming plane 4 which serves to compress the drug powder. The tablet-forming surface layer 5 is designed to prevent the drug powder from adhering to the tablet-forming plane 4 as well as to improve durability. The tablet-forming surface layer 5 contains a base metal as well as a hardening metal and is surface-hardened by the hardening metal. As shown in FIGS. 2 to 4, a hardening metal content is incremental from the base metal toward the tablet-forming surface layer. The hardening metal contains at least any one of W, C, B, Ti, N, and Cr. Any of such hardening metal is contained in the base metal in a fused state so as to harden the tablet-forming surface layer. The hardening metal is made of W and C, Ti and N, Ti and C, W and B, Cr and N, or the like. The hardening metal is selected from such a metal as may be the most compatible with the base metal and serves to harden the tablet-forming surface layer. For example, when the base metal is Ti or Ti alloy, the hardening metal will be made of W and C or of W and B to enable the tablet-forming surface layer to be hardened.

A hardening metal is placed oppositely to the tablet-forming plane so as to serve as an electrode, and an electric discharge is carried out between the electrode and the tablet-forming plane, so that the tablet-forming surface layer can contain the hardening metal in a fused state. In this method, an electric discharge processing is carried out by immersing both the tablet-forming plane of the tablet-forming surface layer and the electrode in the same working oil as employed conventionally in an electric discharge processing process. A discharge energy serves to transfer the hardening metal in the electrode onto the surface of the base metal in a fused state. As shown in FIGS. 2 to 4, the tablet-forming surface layer thus treated in this method reveals that a hard metal concentration is incremental toward the surface side, while a base metal concentration is incremental toward the inner side. FIGS. 2 to 4 depict a concentration of the metal being contained from the surface toward the inner side after having been subjected to an electric discharge processing. As can be seen from these drawings, a concentration of C over the surface becomes higher after having been subjected to the electric discharge processing. The surface portion is polished and removed to a certain thickness after having been subjected to the electric discharge processing. In FIGS. 2 to 4, such polishing operation is continued to reach the vicinity of the chain line “A” after having been subjected to the electric discharge processing. Thus, the position indicated by the chain line “A” will serve as the tablet-forming plane of the tablet-forming surface layer. The tablet-forming plane indicated by the chain line “A” can be designed to cover the range as indicated by the arrow “a” extending horizontally in the drawings. When the chain line “A” is shifted closer to the electrically discharged surface (to the right side in the drawings), a ratio of C increases, with a ratio of the base metal being decreased. The position of the chain line “A”, namely, the tablet-forming plane, should preferably be set to include both of the base metal and the hardening metal.

After the tablet-forming plane has undergone a mirror completion, the base metal is provided with the tablet-forming surface layer by allowing the hardening metal to be contained by electrically discharging the tablet-forming plane. The electrically discharged work surface is transformed from the mirror-finished surface to a rugged surface having a fine irregularity. The irregularity on the work surface, namely the arithmetical mean roughness Ra of the surface is varied in accordance with discharging conditions. For example, a larger amount of discharge energy or discharge current will produce a larger arithmetical mean roughness Ra of the work surface, that is, a larger ruggedness. The work surface has the surface polished in order to obtain a tablet-forming plane through tuning the arithmetical mean roughness Ra of the surface to an optimal value. A surface polishing operation is performed in a shot peening method, in which the work surface is blasted with a fine blasting medium by means of pressurized air. This polishing method is capable of controlling the arithmetical mean roughness Ra of the surface by selecting a particle size of the blasting medium. A smaller, average particle size of the blasting medium will allow the arithmetical mean roughness Ra of the surface to be smaller after the polishing operation. Conversely, a larger, average particle size of the blasting medium will allow the arithmetical mean roughness Ra of the surface to be larger after the polishing operation. Further, since the arithmetical mean roughness Ra of the surface becomes smaller through the polishing operation, a larger extent of polishing operation, in other words, a deeper polishing operation on the work surface will allow the arithmetical mean roughness Ra of the surface to be smaller.

The arithmetical mean roughness Ra of the surface on the tablet-forming plane has an influence on releasability of drug powder. In order to facilitate the releasability of the drug powder, the tablet-forming surface layer is set to range between 0.1 μm and 5 μm in terms of arithmetical mean roughness Ra of the surface. A roughness smaller than 0.1 μm or larger than 5 μm would worsen the releasability of the drug powder. The surface polishing operation with the shot peening method carries an advantage that while the tablet-forming plane is controlled in terms of arithmetical mean roughness Ra of the surface, the amount of polishing operation can be tuned. The polishing operation on the work surface does not necessarily have to be by the shot peening method. For example, a buffing operation is also able to control the arithmetical mean roughness Ra of the surface to obtain an optimal value. The buffing operation is capable of controlling the work surface in terms of arithmetical mean roughness Ra of the surface by changing a buffing material quality or a duration of polishing time.

A thickness of the tablet-forming surface layer can also be controlled by the polishing amount on the work surface. When a polishing amount is made larger, that is, when the position of the tablet-forming plane as indicated by the chain line “A” is shifted toward the left side of the arrow “a”, the tablet-forming surface layer can be made thinner. Also, in the electrically discharging method for allowing the hardening metal to be contained in the base metal, a larger discharge current can make the tablet-forming surface layer thicker. A metallic component in the tablet-forming surface layer is depicted in FIG. 2 with a discharge current of 10A, in FIG. 3 with a discharge current of 5.5 A, and in FIG. 4 with a discharge current of 3A, respectively. As shown in these drawings, a stronger discharge current can increase the thickness of the hardening metal containing layer. Thus, a larger discharge current is capable of making the tablet-forming surface layer thicker. The thickness of the tablet-forming surface layer is arranged to range between 1 μm and 5 μm by controlling the amount of discharge current and the polishing amount. This is because when the tablet-forming surface layer is thinner than 1 μm, the layer is unable to have sufficient durability; and when the tablet-forming surface layer is thicker than 5 μm, a surface crack or fracture is prone to occur.

In the electrically discharging method for transferring the hardening metal onto the surface of the base metal, the tablet-forming surface layer can be hardened to an extremely high hardness of 700-2500 in terms of Vickers hardness (Hv), thus improving durability to a significant extent. It should be noted, however, that the present invention is not limited to an electric discharge processing as a method for allowing the hardening metal other than the base metal to be contained in the tablet-forming surface layer. This is because the punch or die can be manufactured by any method of transferring the hardening metal onto the surface of the base metal in a fused state.

The punch or die can also have a coating layer provided on the surface of the tablet-forming surface layer. The coating layer is provided in a state where the surface is polished by controlling for a predetermined arithmetical mean roughness Ra of the surface. The coating layer serves to harden the tablet-forming plane to a further extent, using such as chromium nitride, diamond-like C, titanium nitride, chromium-dopé-N, titanium carbide, hard chromium plating, and electroless nickel plating. The punch or die, in which the coating layer is further provided on the surface of the tablet-forming surface layer containing the hardening metal in the base metal, can be provided with the coating layer in a less-likely-to-be-detached manner. This is possible because the coating layer can be securely joined with the base metal so as not to be detached.

FIGS. 5 and 6 are photographs illustrating the state how the coating layer will be detached in a test of scratching the tablet-forming plane with a pin. In these photographs, the base metal is Ti alloy, and the coating layer is diamond-like C. In FIG. 5 the coating layer of diamond-like C is deposited directly on the base metal, while in FIG. 6 the coating layer of diamond-like C is deposited on the base metal via the tablet-forming surface layer which contains the hardening metal (made) of W and C. The tablet-forming plane in FIG. 5 has traces of detachment intermediately along both sides of the scratch. The tablet-forming plane in FIG. 6, on the other hand, does not have any trace of detachment throughout the scratch, indicating that the coating layer is firmly joined with the tablet-forming surface layer without detachment.

### EXAMPLE 1

The tablet-forming surface layer was provided on the tablet-forming plane of the punch in the following method.
Ti alloy was used as the base metal. The tip of the base metal was mirror-finished; an electrode of W was disposed at the tip oppositely to the base metal; and an electric discharge processing was performed between the electrode of W and the base metal for six minutes. The electric discharge processing was performed at a voltage of 350 V between the punch and the electrode, with a current of 10 A, with a distance of 2 μbetween the electrode and the base metal, and with an outer diameter of 7 mm at the tip of the base metal which serves as the tablet-forming plane.

Through the above-described electric discharge processing, the surface of the base metal came to contain the hardening metal of W and C in a fused state as shown in FIG. 2. Then, the shot peening operation was performed for polishing the surface to the position indicated by the chain line “A”. The shot peening operation employed a blasting medium with an average particle size of 1 μm.

In the punch manufactured as above, a surface hardness in the tablet-forming plane reached 2000 in terms of Vickers hardness (Hv), and the arithmetical mean roughness Ra of the surface was 2 μm. Using this punch, when drug powder, which contained 97 parts by weight of ascorbic acid, 3 parts by weight of cornstarch, and 0.2 parts by weight of magnesium stearate, was compressed with 100 N to form tablets, the punch employed in this Example revealed that almost none of the drug powder was adhered to the punch after producing 2400 pieces of tablets.

By way of comparison, when the same drug powder was compressed with a punch which was made of the base metal alone without having a tablet-forming surface layer provided, this punch had drug powder adhered on the surface after producing 200 pieces of tablets, making it impossible to produce additional pieces of tablets.

### EXAMPLE 2

The punch was manufactured in the same manner as in Example 1, except that a polishing medium and a duration of blasting time were controlled in the shot peening operation to prepare the tablet-forming plane in a small roughness of 0.8 μm in terms of the arithmetical mean roughness Ra of the surface. Using this punch, when drug powder, which contained 50 parts by weight of ibuprofen (20 μm), 32.9 parts by weight of lactose, 14.1 parts by weight of cornstarch, and 0.2 parts by weight of magnesium stearate, was compressed with 100 N to form tablets, the punch employed in Example 2 revealed that almost none of the drug powder was adhered to the punch after producing 2400 pieces of tablets.

By way of comparison, when the same drug powder was compressed with a punch which was made of the base metal alone without having a tablet-forming surface layer provided, this punch had drug powder adhered on the surface, from the beginning, making it impossible to produce any pieces of tablets.

As can be seen from the above, the punch in these Examples is capable of forming more than 2400 pieces of tablets from the drug powder which contains an extremely small amount of 0.2 parts by weight of magnesium stearate and which is extremely difficult to compress into tablets, and yet adhesion of the drug powder to the punch is reduced to minimum. In order to form tablets, the drug powder in these Examples, if necessary, may require use of the punch which has a coating layer of, for example, CrN provided on the surface. While a punch provided with a coating layer has a risk that metal in the coating layer is likely to be detached, the punch in these Examples carries an advantage that difficult-to-be-formed-into-tablets drug powder can be formed into beautiful tablets, without having to have a coating layer provided. Thus, eliminating a disadvantage that a tablet is contaminated by metal of the coating layer, the difficult-to-be-formed-into-tablets drug powder can be formed into beautiful tablets.

### EXAMPLE 3

A punch was manufactured in the same manner as in Example 1, except that diamond-like C was laminated/deposited/layered on the tablet-forming plane of the punch which was processed under the same conditions as in Example 1. When this punch was employed, even better releasability of drug powder and higher durability were obtained than when using the punch in Example 1. Since the coating layer was joined with the base metal via the tablet-forming surface layer which contained W and C, the coating layer can be joined with the base metal so as not to be detached, as mentioned above. Thus, it is advantageous that the metal in the coating layer will be securely prevented from being detached to contaminate tablets.

While the above-mentioned Examples are focused on providing a tablet-forming surface layer on the surface of a punch and additionally providing a coating layer, the same arrangement can also apply in the case of a die surface, in which the die is provided with a tablet-forming surface layer on the surface of the die and additionally with a coating layer, so that releasability of drug powder can be improved along with mechanical durability.

### INDUSTRIAL APPLICABILITY

Since the inventive punch or die for tabletting is capable of obtaining excellent durability and releasability, it is possible to efficiently produce a great number of tablets, while ideally compressing drug powder to form tablets in a safe and secure manner by preventing a adhesion of the drug powder to the punch or die and contamination of tablets by metal.

### BRIEF DESCRIPTION OF DRAWINGS

FIG. 1 is a partially enlarged cross-sectional view showing the punch and die for tabletting in accordance with an embodiment of the present invention;

FIG. 2 is a graph showing an example of metal concentration in the hardening metal contained as distributed from the surface of the base metal toward the inner side;

FIG. 3 is a graph showing another example of metal concentration in the hardening metal contained as distributed from the surface of the base metal toward the inner side;

FIG. 4 is a graph showing a further example of metal concentration in the hardening metal contained as distributed from the surface of the base metal toward the inner side;

FIG. 5 is a photograph showing the result of detachment test of the coating layer which is deposited directly on the base metal; and

FIG. 6 is a photograph showing the result of detachment test of the coating layer which is deposited on the base metal via the tablet-forming surface layer.

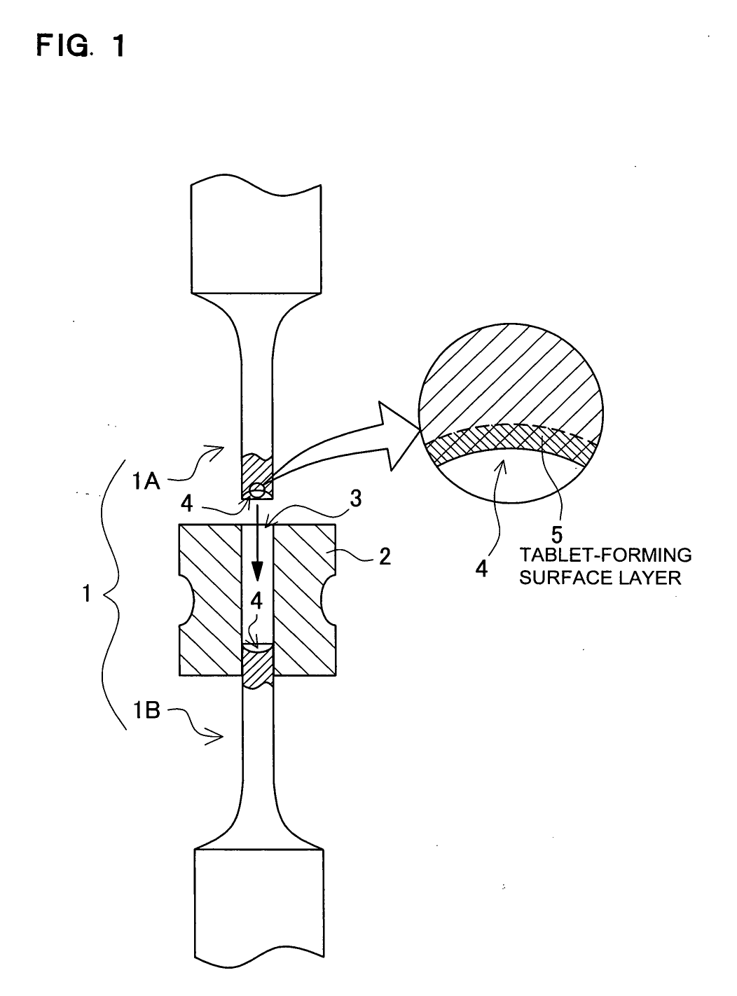

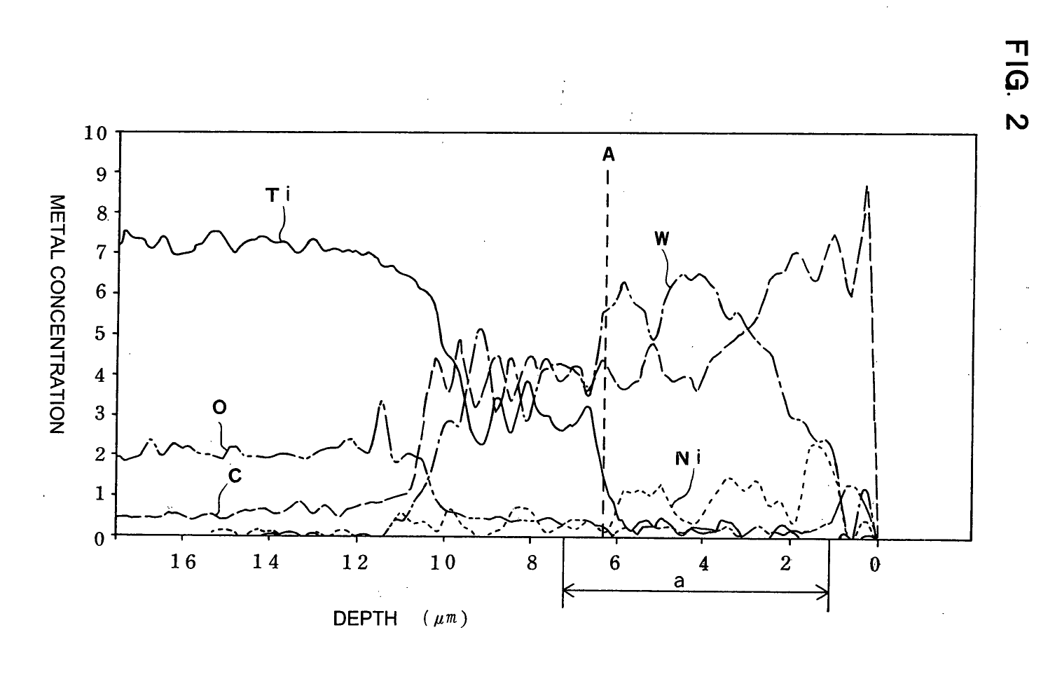

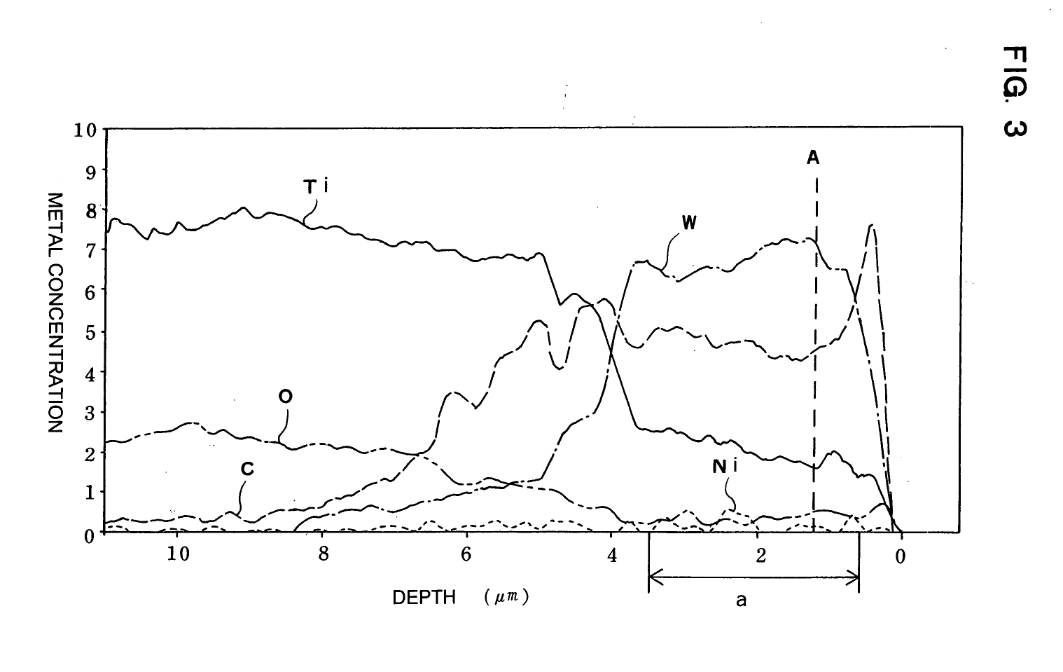

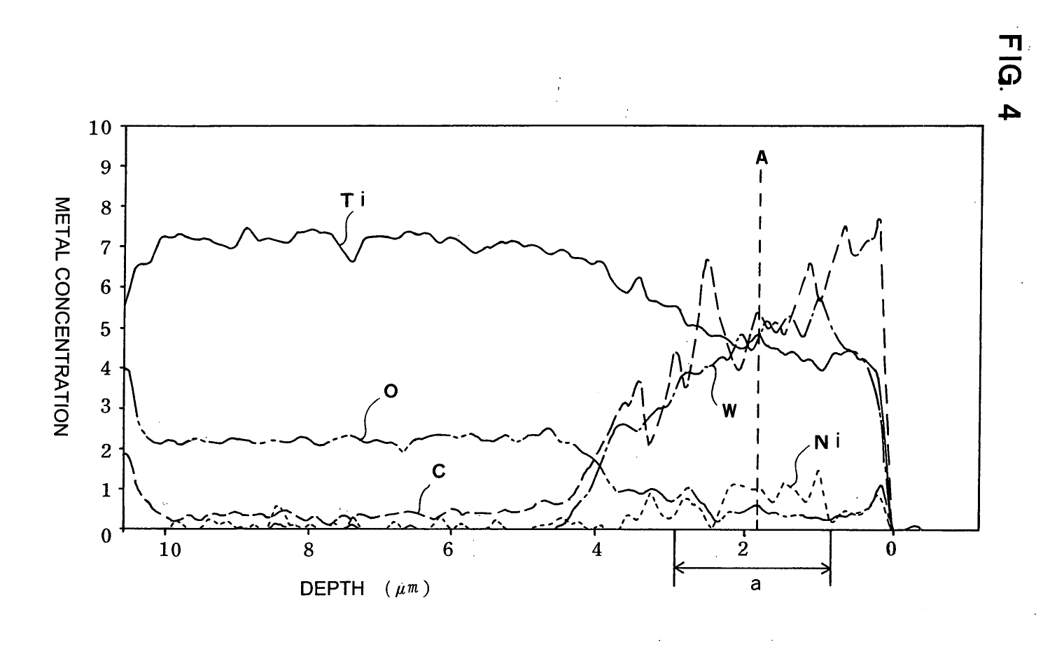

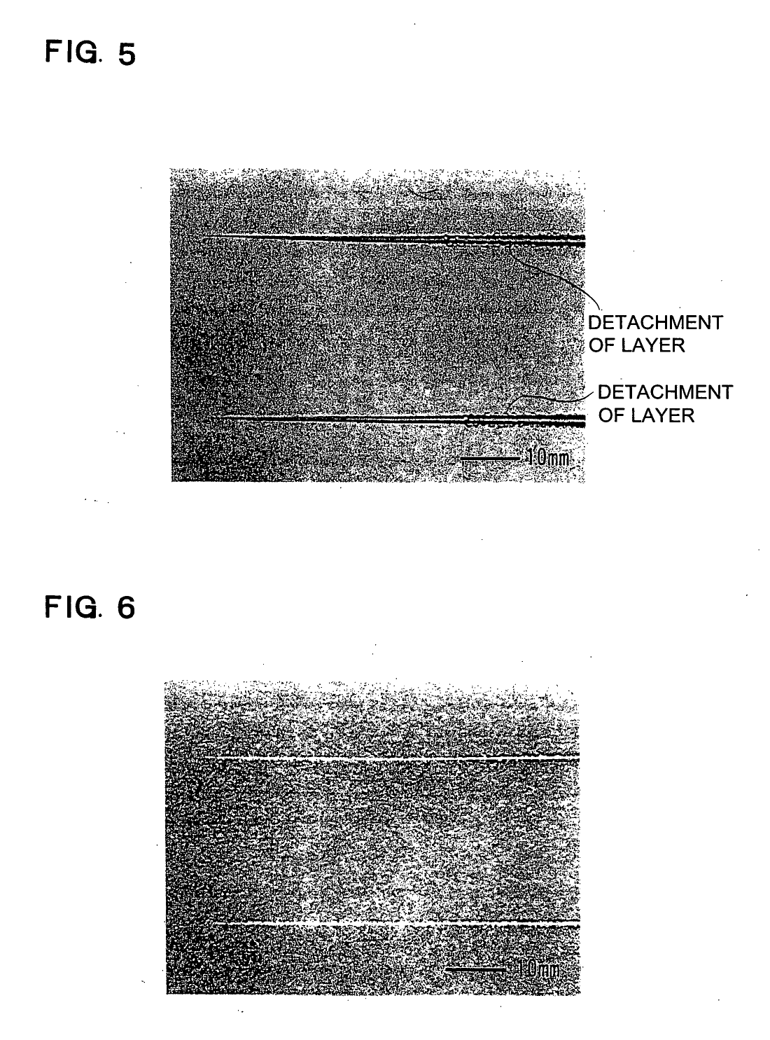

### DENOTATION OF REFERENCE NUMERALS

1 Punch
1A Upper Punch
1B Lower Punch
2 Die
3 Die Bore
4 Tablet-Forming Plane
5 Tablet-Forming Surface Layer

1. A punch or die for tabletting,
wherein a tablet-forming surface layer (5) comprises a base metal as well as a hardening metal being different from the base metal, with a content of the hardening metal being incremental from the base metal toward the tablet-forming surface layer (5) and with the hardening metal including at least any one of W, C, B, Ti, N, and Cr; and
that an arithmetical mean roughness Ra of a surface in the tablet-forming surface layer (5) ranges between 0.1 μm and 5 μm.

2. The punch or die for tabletting according to claim 1, wherein the hardening metal content of the tablet-forming surface layer (5) is 20% or more by weight of the base metal.

3. The punch or die for tabletting according to claim 1, wherein the tablet-forming surface layer (5) ranges between 1 μm and 5 μm

4. The punch or die for tabletting according to claim 1, wherein the base metal is any one of iron, iron alloy, Ti, Ti alloy, stain sintered metal.

5. The punch or die for tabletting according to claim 1, wherein the base metal is titanium or titanium alloy, and the hardening metal is made of W and C.

6. The punch or die for tabletting according to claim 1, wherein the tablet-forming surface layer (5) has a coating layer provided on a surface thereof.

7. The punch or die for tabletting according to claim 6, wherein the coating layer is any one of chromium nitride, diamond-like C, titanium nitride, chromium-dopé-N, titanium carbide, hard chromium plating, and electroless nickel plating.

8. The punch or die for tabletting according to claim 1, wherein the tablet-forming surface layer (5) contains the hardening metal by electric discharge processing of the surface of the base metal with an electrode containing the hardening metal.

9. The punch or die for tabletting according to claim 1, wherein the surface of the tablet-forming surface layer (5) is blasted with a particulate or powdery object, allowing the arithmetical mean roughness Ra of the surface to be controlled.

10. The punch or die for tabletting according to claim 4, wherein the base metal is titanium or titanium alloy, and the hardening metal is made of W and C.
